(19) United States
(12) Patent Application Publication
(10) Pub. No.: US 2004/0216084 A1
(43) Pub. Date: Oct. 28, 2004

(54) System and method of managing web content

(76) Inventors: Albert C. Brown, Huntington Beach, CA (US); Philippe M. Burlina, Irvine, CA (US); Stephane Depuy, Irvine, CA (US); Shuang Wang, Irvine, CA (US); Damon Anderson, Washington, DC (US); Jacob Van Wingen, Washington, DC (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/758,954

(22) Filed: Jan. 16, 2004

Related U.S. Application Data
(60) Provisional application No. 60/441,429, filed on Jan. 17, 2003.

(51) Int. Cl. G06F 9/44; G09G 5/00; G06F 17/60

(52) U.S. Cl. 717/102; 345/762; 705/7

(57) ABSTRACT

Systems and methods provide one or more automated tools for controlling web site deployment and governing content update. Such tools ensure a consistent look-and-feel for a deployed web site, accurate content, and web site referential integrity. A web content engine advantageously manages a wide variety of web site components which are building blocks of a web site. The web content engine also manages information about relationships among the various components. In addition, the web content engine may also associate one or more workflow processes with individual components and with groups of components. A workflow process may automatically be executed when associated web content is created, modified, deleted, or the like. The web content engine may also include a deployment service that ensures that newly created or modified components are deployed in a manner that maintains the consistency or referential integrity of a web site.

### RELATED APPLICATIONS

This application claims the benefit of U.S. Provisional Application No. 60/441,429, which was filed Jan. 17, 2003. This application is being filed concurrently with related U.S. patent application Ser. No. ______, titled “Content Manager Integration,” Attorney Docket No. FILNTP.395A. The foregoing provisional application and related application are hereby incorporated in their entirety by this reference.

### BACKGROUND OF THE INVENTION

1. Field of the Invention

Aspects of the invention relate to designing, updating, and managing content deployed to web sites.

2. Description of the Related Art

The World Wide Web (“web”) provides an increasingly popular medium for publishing content, including all types of data and computer-based services and applications. Many organizations provide one or more web sites that publish, via the web, a variety of content. Several factors contribute to the popularity of the web among organizations and individuals. The web allows organizations to link related content, even content located on different web sites, using hyperlinks. The web is, compared to print publications, relatively quick and inexpensive to update. Changes made to web sites may become effective immediately, such that users may access updated content as soon as it has been added to a web site. Outdated information and links to outdated information may be removed, and replaced with newer information or links to newer information. Indeed, the web typically includes a large amount of dynamic, often-changing content.

In light of the foregoing popularity, organizations often struggle to manage web content to ensure its accuracy. Web site development tools rely on human web developers or authors to enforce a procedure for updating web sites. Over-reliance on human web developers, however, often introduces a number of potential errors into the process of deploying and updating web sites. Such errors occur when, for example, a developer deletes content linked to by other content, leaving so-called “dead links.” Errors may also occur when developers alter the directory structure of a web site, without updating links that point to the moved content. Additionally, errors may occur when developers update a web site in piecemeal fashion, such as, for example, by adding a new company logo to one page of a web site while leaving an outdated company logo on several other pages, such that the web site does not present a consistent logo to users. These and other drawbacks are often associated with conventional Web development tools.

### SUMMARY OF THE INVENTION

Embodiments of the systems and methods described herein provide one or more automated tools for controlling web site deployment and governing content update. Such tools ensure a consistent look-and-feel for a deployed web site, accurate content, and web site referential integrity. In one embodiment, a web content engine advantageously manages a wide variety of web site components which, as used herein, and according to a web-site design architecture of embodiments of the system, are building blocks of a web site. Such components may be atomic components, such as, for example, string components that store a text fragment or asset components that store a binary object such as, for example, a logo image file. Additionally, components may be structured components, defining structure for a portion of a web site or series of pages and including references to one or more atomic components or other structured components. Such structured components may include composite components, template components, and page components. Page components define structural elements and include references to other components such that the structural elements and referenced components may be rendered into displayable web pages. Composite components may be nested within each other and within page components. According to an embodiment, a hierarchical folder or directory structure can be employed to assist in managing the components. The foregoing component-based architecture advantageously assists in content reuse, thereby allowing developers to develop web sites more efficiently and to ensure a consistent look-and-feel throughout a website. This allows developers the option of creating content only once, no matter how many places it appears in a site.

According to an embodiment, the web content engine also manages information about relationships among the various components. For example, a component relationship may include one component linking to another component, such as by a hypertext link. Another may include one component referencing another component, such as, for example, a page component referencing a string component such as a copyright statement. The foregoing exemplary page component defines a web page that, when rendered, includes the text of the copyright statement. The foregoing management of relationships advantageously assists the web content engine in ensuring, for example, the functional integrity of the web site.

According to an embodiment, the web content engine can also associate one or more workflow processes with individual components, with groups of components, some or all of the same, or both. A workflow process may automatically be executed when associated web content is created, modified, deleted, or the like. These workflow processes assist developers in maintaining websites because they may automate such tasks as ensuring that web content has been properly approved prior to deployment, that all related content is deployed to the web site at once, and the like. Automated workflow processes also reduce potential human error by enforcing consistent standards for updating, approving, and deploying web site content.

According to yet another embodiment, the web content engine may include a deployment service that ensures that newly created or modified components are deployed without harming consistency or referential integrity of a web site. Advantageously, the deployment service may have access to metadata concerning each component, including, for example, whether each component is deployable or whether each component has been approved for deployment. Additionally, the deployment service may deploy related components as one transaction such that a failed transaction may be backed out. In an advantageous embodiment, the deployment service automatically adds related components to a deployment transaction even if the related components have not been selected for deployment. This transactional deployment advantageously ensures that related components are deployed together or not at all, thus preventing the creation of dead links and other problems.

The foregoing and other tools described in further detail herein perform a number of methods related to the maintenance of a web site. One such method is a method of retaining referential integrity of an updated web site. In an embodiment, an update of a web site component is detected and a content approval workflow process is executed upon the updated component. Additionally, component relationships are reviewed to determine components that depend on the updated component. In an embodiment, a dependent update workflow process also executes on each of the identified dependent components. Advantageously, the execution of the foregoing content approval workflow processes and dependent update workflow processes ensures that web sites are updated according to set procedures that preserve referential integrity.

In light of the foregoing, the systems and methods described herein control web site deployment and content update, ensure a consistent look-and-feel for a deployed web site, and ensure that web site content remains accurate and retains referential integrity. Embodiments of the system and method will now be described in greater detail with reference to the following drawings.

### BRIEF DESCRIPTION OF THE DRAWINGS

FIG. 1A is a block diagram illustrating an exemplary embodiment of a web content management system.

FIG. 1B is a block diagram illustrating an exemplary embodiment of a web content engine as illustrated in FIG. 1A.

FIGS. 2A-2B are a block diagram illustrating an embodiment of tree structured component relationships maintained by the web content management system of FIG. 1A

FIG. 2C is a simplified screen shot of an exemplary web page rendered using the component relationships of FIG. 2A.

FIG. 2D is a simplified screen shot of another exemplary web page rendered using some of the same component relationships of FIG. 2B.

FIG. 3 is a flowchart illustrating an exemplary web content update process.

FIG. 4 is a graphical representation of an exemplary progression of a content approval workflow process.

FIG. 5 is a flowchart illustrating an exemplary dependent update workflow process.

FIG. 6 is a simplified screen shot of an exemplary rendered web page modified using the web content management system of FIG. 1A.

### DETAILED DESCRIPTION OF THE PREFERRED EMBODIMENT

Organizations rely on human web developers to deploy web sites, add content to web sites, delete content from web sites, and otherwise update web sites. With each modification to a web site, errors may be introduced into a web site. Embodiments of the systems and methods described herein provide one or more automated tools for minimizing such errors by controlling web site deployment and governing content update. Such tools ensure a consistent look-and-feel for a deployed web site, accurate content, and web site referential integrity. Additionally, the systems and methods described herein provide a component-based architecture that allows web developers to reuse content, thus promoting quicker and more efficient web site development and deployment.

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

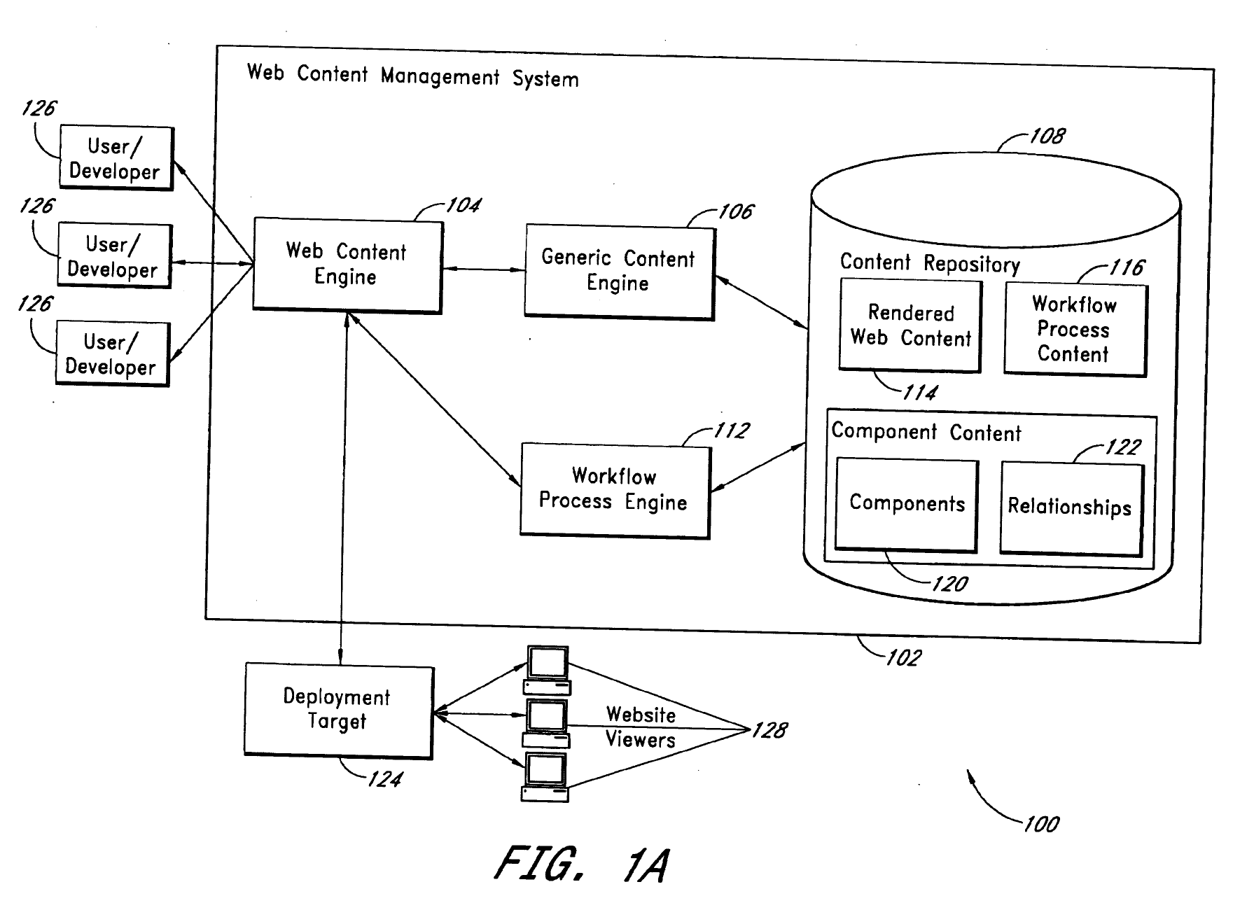

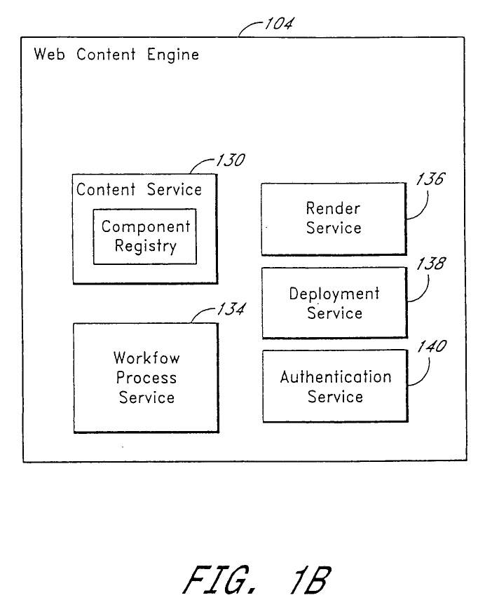

FIG. 1A is a block diagram illustrating an exemplary embodiment of an environment 100 for managing web content. According to an embodiment, a web content management system 102 comprises a web content engine 104, a generic content engine 106, a content repository 108, and a workflow process engine 112. In one embodiment, the web content engine 104 provides access, to the web content management features described herein, to one or more users or developers 126. The users or developers 126, hereinafter called developers 126, include humans and/or automated processes that develop web sites, add content to web sites, modify content on web sites, delete content from web sites, or the like. In one advantageous embodiment, the web content engine 104, the generic content engine 106, and the workflow process engine 112 comprise computer-executable code configured to perform some or all of the functions herein described. A skilled artisan will appreciate that such computer-executable code may be developed using any number of computer languages, development tools, or the like. Additionally, the computer-executable code may be compiled into object code capable of running on any computer system known in the art, or which becomes known in the art. Alternatively or additionally, the computer-executable code may be interpreted rather than compiled, or compiled into a code that is in turn interpreted. A skilled artisan will appreciate, in light of this disclosure, that the functions described herein may also be performed wholly or partially in hardware or in firmware.

In one embodiment, the content repository 108 is a general content repository that stores a variety of content. “Content” as used with regard to content stored by the general content repository is a broad term, encompassing its ordinary meaning and including all types of content that can be managed by one or more of a content management system, a document management system, a business process management system or the like as understood by a skilled artisan. Examples of such content include all types of electronic data, including binary data, structured data, such as data stored in databases, unstructured data, such as image documents, folders, word processing documents, CAD/CAM documents, source code files, object code files, physical documents, physical objects, and the like. In general, content management systems are also able to manage physical documents and objects not residing within the system by storing and managing metadata about the physical documents and objects.

FIG. 1A illustrates the content repository 108 as a single block element, however, a skilled artisan will recognize from the disclosure herein that the content repository 108 can comprise any data storage system or systems, logically or geographically remote from one another and employing any type of known data storage schemes. For example, the content repository 108 may include a cluster of databases using sophisticated data mirroring or replication to ensure data availability, or the like.

Of particular relevance to this disclosure is content stored by the content repository 108 that relates to content published on a web site. In one embodiment, the content stored by the content repository 108, includes rendered web content 114, workflow process content 116, and component content 118. Rendered web content 114 comprises content assembled into a final form for inclusion as one or more web pages in a web site. The rendered web content 114 is rendered from the component content 118. As used herein, a web page is a tangible representation of the rendered web content 114, or that which a web site viewer 128 views or hears. A skilled artisan will appreciate, in light of this disclosure, that there exist many formats of content that contribute to the generation and display of a web page. Web pages may be generated in whole or in part using formats readily known to one of ordinary skill in the art such as, one or more of a number of the following and many other formats of content: HTML, XML, Java, Javascript, CGI files, GIF files, JPEG files, MPEG files, AVI files, WAV files, and text files. The rendered web content 114 includes all of the foregoing formats of content and all other content, regardless of format, that helps define a web page. According to an embodiment, the rendered web content 114 has been rendered into a form that, if deployed to a web server on the web, would be accessible to a web browser without further modification.

According to an embodiment, the workflow process content 116 comprises one or more workflow process definitions, each of which defines a workflow process for processing content. In an embodiment, a workflow process is a broad concept which includes its ordinary meaning and usually comprises one or more ordered steps or operations to be performed by one or more participants on associated content. The participants may be humans or automated processes. For example, an exemplary workflow process which may be useful to the web content engine for managing web content is a workflow process in which one or more reviewers, such as, for example, a web site development supervisor and a product sales supervisor, review any additions, modifications, or deletions to content before the content is deployed to an accessible web server. According to an exemplary workflow process, each reviewer may approve the content for publication, edit the content prior to approving the content for publication, reject the content or the like. Advantageously, each workflow process may define what happens if each option is taken. For example, a workflow process may specify that when a reviewer rejects a proposed modification of content, the person that originally proposed the modification has a chance to edit the modification. Alternatively, a workflow process may specify that rejections result in erasing any modification, without any further input. In one embodiment, the workflow process content 116 is encoded using a description language. In one embodiment, the workflow process content 116 is encoded using XML. Advantageously, a graphical or other workflow process design tool may be provided to allow users without programming experience to design workflow processes. Additionally, preset workflow processes that do not require design, or that require only minimal modifications, may be provided with the system.

As shown in FIG. 1A, an embodiment of the content repository 108 includes the component content 118 comprising components 120 and component relationships 122. The components 120 define building blocks of a web site. In one embodiment, the component relationships 122 relate the components 120 together in an ordered structure, such as a hierarchial tree, such that, for example, certain of the components 120 may be nested within others of the components 120. In addition, the components 120 may be stored in a number of data structures, such as, for example, a tree, linked lists, database records, file systems, and the like. In one embodiment, the components 120 are stored as database records. Advantageously, a single database may include all the components 120 that make up a particular web site. Alternatively or additionally, the components 120 may be stored in multiple databases. Additionally, the components 120 may be stored as files within a file system. The foregoing data structures may be stored locally, externally, or distributed such that they are stored on a number of local sources, external sources, or a combination of local and external sources.

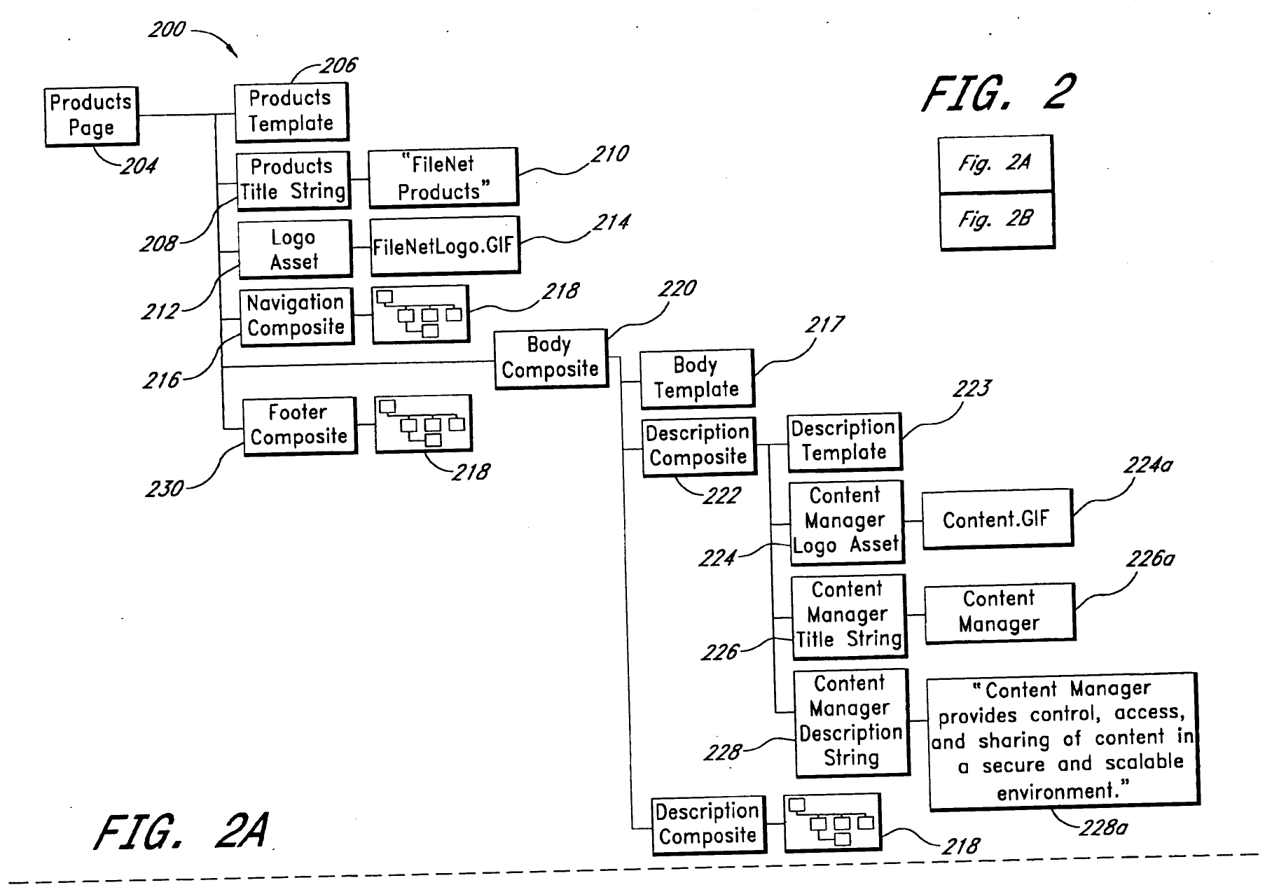

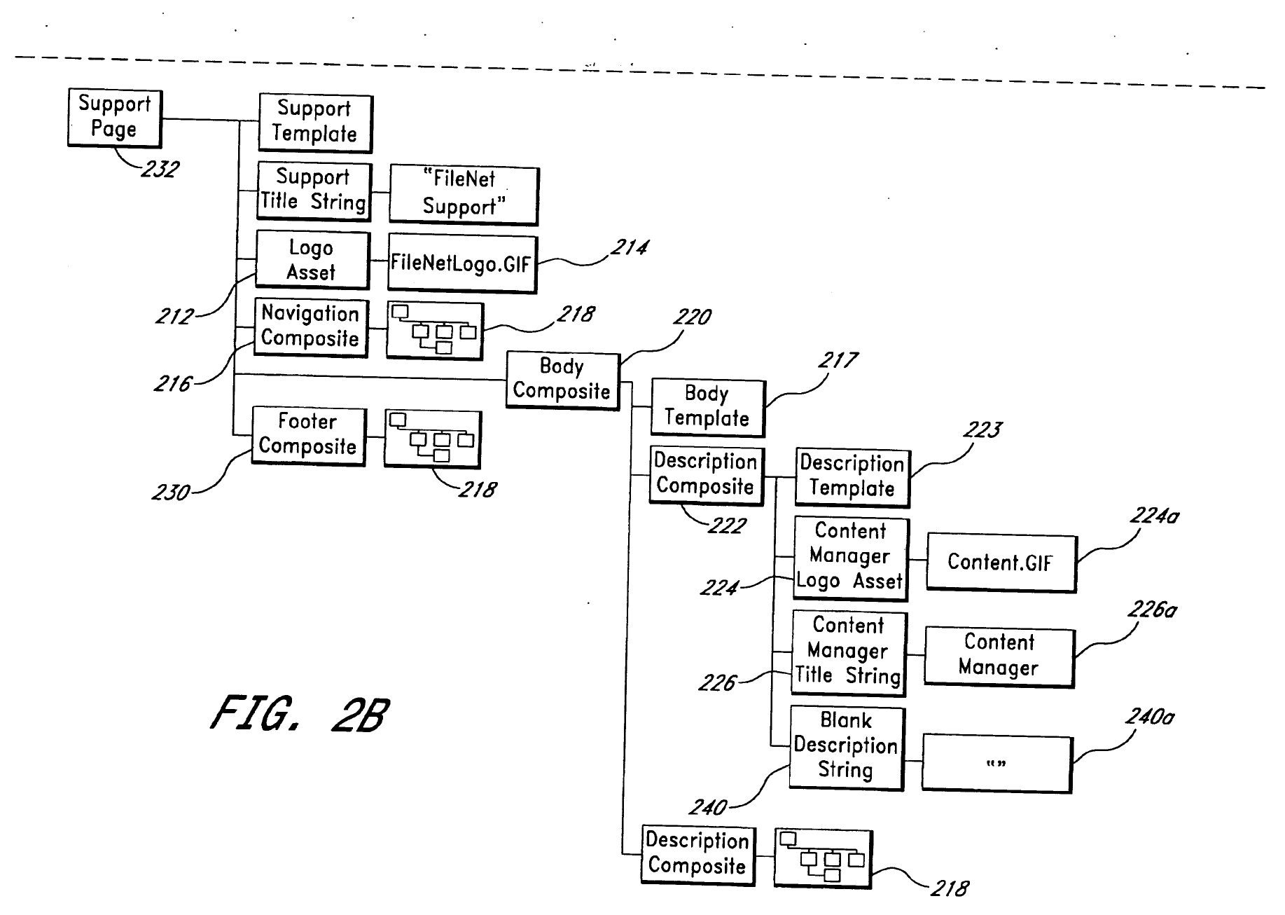

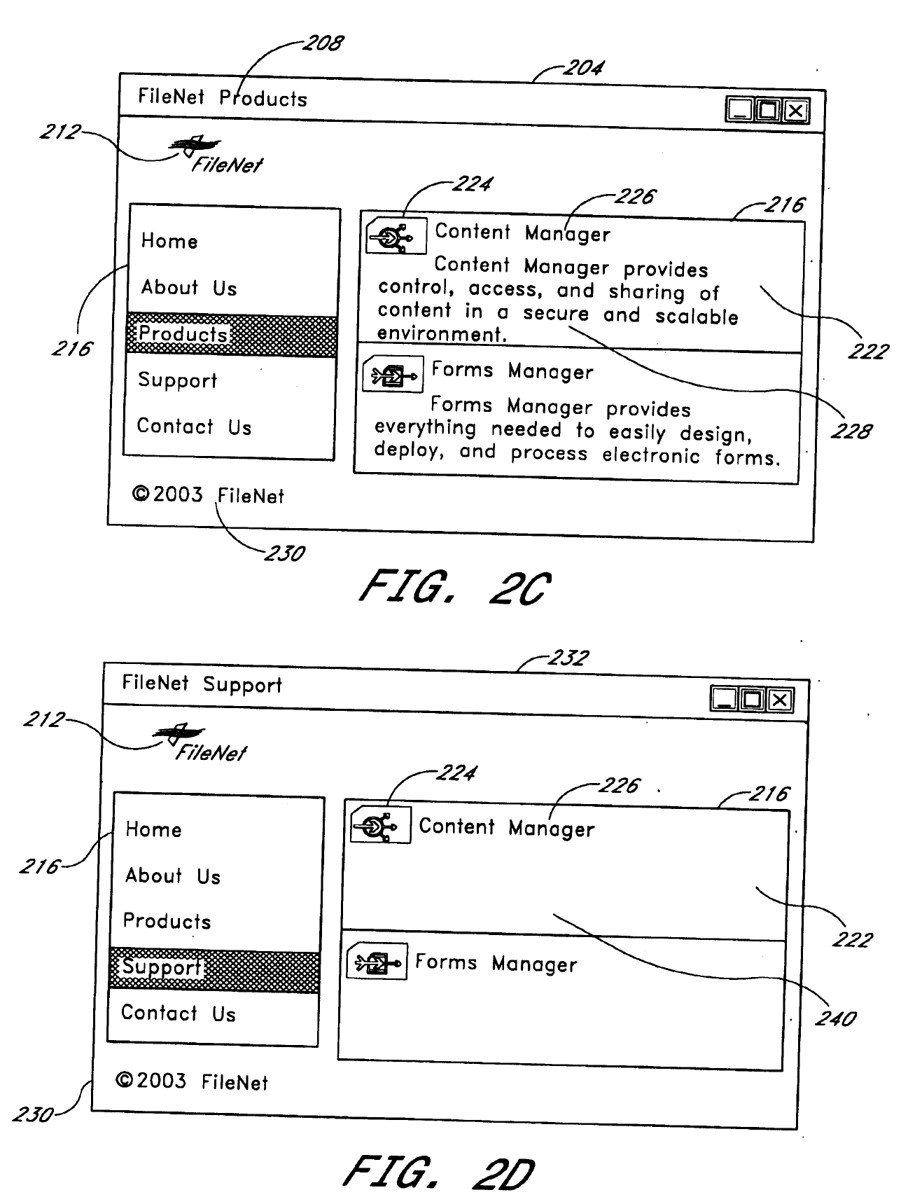

As will now be explained with reference to FIGS. 2A-2D, the foregoing component-based architecture advantageously facilitates content reuse. In one embodiment, each component comprises a reference, or a name or identifier that identifies the component. Developers 126 and automated processes, such as, for example, the web content engine 104, may quickly refer to each component by its reference, further promoting content reuse. Such content reuse promotes quick and efficient web site development. Additionally, this content reuse makes it easier for developers 126 to develop web sites that have a consistent look-and-feel, such as web sites that consistently present an organizational logo and other identifying information of the company, along with a consistent menu bar or other web site navigational system. Furthermore, content reuse makes it easier to maintain consistent semantics across a web site. For example, a developer may use a consistent textual description of a product wherever that product is referenced on a web site. This allows an organization to publish a consistent message on its web site.

Additionally, the foregoing component-based architecture promotes web site integrity in a number of ways, such as, for example, by promoting a component-based transactional deployment system, whereby related components are deployed to an accessible web site as a group or not at all. The component-based architecture also promotes component-level detection of changes to a web site design, allowing the workflow process engine 112 to launch, when changes are made to one or more of the components 122, workflow processes designed to protect functional integrity of the web site. For example, workflow processes can promote referential integrity by preventing dead links. A skilled artisan will appreciate, in light of this disclosure, that the component relationships 122 may be stored in a number of data structures, including, for example, database tables, linked lists, trees, and the like. In one embodiment, the component relationships 122 are stored as a series of tables, such that each table entry includes a field with a reference of a first component and a group of fields with one or more references of components that relate to the first component.

FIGS. 2A-2B are a block diagram, illustrating an ordered tree 200 representing a simplified example of component relationships maintained by the web content management system 102 of FIG. 1A. As illustrated, the component relationships 122 have a multi-level hierarchical organization, starting with a root node 202. In the illustrated example, one or more page components, such as a products page component 204 and a support page component 232, directly descend from the root node 202. As illustrated with regard to the products page component 204, a page component, in one embodiment, generally comprises a page template, such as products template 206, and one or more other components such as, for example, products title string component 208, logo asset component 212, navigation composite component 216, body composite component 220, and footer composite component 230. As will be appreciated by a skilled artisan, the foregoing components represent a number of different component types, page components, template components, composite components, string components, and asset components. General characteristics of each of these component types will now be described. Page components, template components, and composite components are structured components, in that they may describe a combination of more than one component. Page components are so-named because they include, by association, a group of components that, when combined together and rendered into the rendered web content 114, define a viewable web page. As illustrated, in one embodiment, page components include by reference the components that descend from them. Template components, such as the products template 206, structurally define a group of components, such as, for example, by providing formatting codes that define where each of the group of components is to be positioned on a viewable web page. In one embodiment, template components may be encoded in a description language such as, for example, HTML or XML. Composite components such as the body composite component 220, like page components, comprise a template component and one or more other components. In one embodiment, composite components provide both structure and content for a particular portion of a web page, and may thus be considered to be pseudo mini-page components. In one embodiment, composite components may be nested. Any number of nesting levels may be provided.

String components and asset components are atomic components, pointing to, in one embodiment, one portion of content that may be displayed on a web site. For example, the products title string 208 points to the text string “FileNet Products” 210. Asset components, such as the logo asset component 212, point to binary objects, such as, for example, logo images, other images, sound files, video files, executable objects such as applications, procedures, functions, or methods, word processing documents, and the like. For example, in the illustrated embodiment, the logo asset component 212 points to a binary object titled “FileNetLogo.GIF,” 214 which, as illustrated in FIG. 2C, depicts a company logo. As illustrated, a number of additional component boxes 218 illustrate locations in which the tree may continue but where, for ease of illustration, not all tree nodes are depicted.

As further illustrated, a branch of the tree 200 beginning with the support page component node 232 illustrates how the component-based architecture as disclosed herein facilitates component and content reuse. In particular, a skilled artisan will appreciate, in light of this disclosure, that all but one of the exemplary nodes beginning with and descending from the description of exemplary composite node 220 include an identical component to corresponding nodes beginning with and descending from the description exemplary composite node 222 which descends from the products page component 204. Note, in this respect, with regard to the illustration, that nodes that include identical components are referenced using identical reference numbers. As will be appreciated by a skilled artisan by comparing FIG. 2A with FIG. 2B, the support page component 232 of the example is constructed using a number of components that are identical to components of the products page component 204. For example, as illustrated, the support page component 232 includes, among many other shared components, the following shared components: logo asset 212, navigation composite 216, body composite 220, body template 217, description composite 222, description template 223, content manager logo asset 224, content manager title string 226, and footer composite 230.

A skilled artisan will appreciate, in light of this example, that the component-based architecture described herein enables a developer 126, in designing a web site, to quickly and efficiently reuse components across multiple portions of a web site. This capability allows a developer 126 to more quickly develop a site and promotes a consistent look-and-feel throughout the site. For example, a developer 126 may develop a site with a consistent menu and navigation structure by including a navigation component, such as the navigation composite component 216 in multiple page components throughout the site.

FIGS. 2C-2D are simplified screen shots of simplified web pages that show rendered textual and graphical elements that correspond to the components depicted by the nodes of the tree 200. Additionally, comparing FIG. 2C to FIG. 2A, and FIG. 21) to FIG. 2B, FIGS. 2A-2D illustrate graphically how the content reuse facilitated by the component-based architecture described may be used to develop similar web pages that maintain a consistent web site look-and-feel. Referring now to FIGS. 2A-2D, displayed textual or graphical elements corresponding to various nodes of the tree 200 may now be identified by referring to the reference numerals of the figures. Specifically, rendered textual and graphical elements on FIGS. 2C-2D are referenced using the reference numerals of the components depicted on FIG. 2A-2B to which they correspond.

Referring again to FIG. 1A, in one embodiment, the web content management system 102 updates viewable web sites by deploying the rendered web content 114 to a deployment target 124. The deployment target 124 comprises one or more web servers capable of serving web pages to a plurality of web site viewers 128. According to an embodiment, the deployment target 124 is logically and/or geographically external to the web content management system 102. For example, the deployment target 124 may be or be on an external network node. Alternatively or additionally, the deployment target 124 may be within the web content management system 102. Advantageously, the web content management system 102 may deploy the rendered web content 114 to the deployment target 124 after any changes in the rendered web content 114 have been processed according to one or more of the workflow definitions of the workflow process content 116. In this manner, changes made by developers 126 are initially stored within the component content 118, and wait there pending processing by the workflow process engine 112.

FIG. 1B is a block diagram illustrating an exemplary embodiment of a web content engine as illustrated in FIG. 1A. According to an embodiment, as illustrated, the web content engine 104 comprises a content service 130, a workflow process service 134, a render service 136, a deployment service 138, and an authentication service 140. In one advantageous embodiment, each of the foregoing services, the content service 130, the workflow process service 134, the render service 136, the deployment service 138, and the authentication service 140 comprise computer-executable code configured to perform the functions herein described. A skilled artisan will appreciate that such computer-executable code may be developed using any number of computer languages, development tools, or the like. Additionally, the computer-executable code may be compiled into object code capable of running on any computer system known in the art, or which becomes known in the art. Alternatively or additionally, the computer-executable code may be interpreted rather than compiled, or compiled into a code that is in turn interpreted. A skilled artisan will appreciate, in light of this disclosure, that the functions described herein may also be performed wholly or partially in hardware or in firmware.

In one embodiment, the content service 130 communicates with the generic content engine 106 in order to receive content from the content repository 108. Advantageously, the component content 118 may be stored in a general content repository whose content may be accessed and manipulated by the generic content engine 106. In one embodiment, the generic content engine 106 includes powerful features for manipulating content, including, for example, sorting content, indexing content, searching for content by keyword or metadata property, entering content, tracking content entry by other applications, monitoring check-in and check-out of content, providing security of content, keeping track of version information, and the like. Advantageously, the generic content engine 106 has the advantageous features of commercially available systems known in the art as enterprise content management systems, document management systems, business process management systems, and the like, such as, for example, systems commercially available from FileNet Corporation of Costa Mesa, Calif., including software products marketed under the names of “FileNet Business Process Manager,” “FileNet Content Manager,” and “FileNet Web Content Manager,” the details of which are incorporated herein by reference. Advantageously, the web content engine 104 may take advantage of the features of the generic content engine 106. Alternatively, or additionally, the web content engine 104 may itself have these features and execute them directly, such as by directly accessing the component content 118 from the content repository 108, or the web content engine 104 may have some direct access to the content repository 108 and may indirectly access the content repository 108 through the generic content engine 106 at times. According to an embodiment, the content service 130 may comprise a component registry 132 that tracks the components 120 and their relationships 122. In one embodiment, the component registry 132 assists the content service 130 to identify components for retrieval from the content repository 108 and for further processing by the web content engine 104.

According to an embodiment, the render service 136 renders web content based on the components 120 and component relationships 122. Upon rendering web content, the render service 136 stores the resulting rendered web content 114 in the content repository 108. Upon being rendered, the rendered web content 114 may be deployed to the deployment target 124. However, in one embodiment, the rendered web content 114 is not necessarily automatically deployed to the deployment target 124. In addition, in one embodiment, the render service 136 also maintains the component relationships 122. This maintenance of the component relationships 122 allows the render service 136 to determine which components depend on each other. Advantageously, the web content engine 104 is able to use such information concerning component dependency by, for example, verifying that components that depend on components that have been modified are properly deployed, without a loss of referential integrity.

According to an embodiment, the deployment service 138 deploys rendered web content 114 to the deployment target 124. In one embodiment, deployment occurs according to set procedures to ensure that the deployed web site maintains its functional integrity. In one embodiment, the deployment service 138 establishes a number of deployment jobs, where a deployment job defines a transaction in which one or more components is deployed to the deployment target 124. According to an embodiment, the deployment service 138 deploys components within a deployment job in a transaction. The effect of such transactional deployment is that either every component within the job is deployed, or none of the components are deployed. In one embodiment, in the event that a deployment job fails, the deployment service 138 executes a rollback of the job such that the deployment target 124 remains as if no part of the deployment occurred. Advantageously, this feature prevents errors in which one portion of a site is updated but another is not updated, thus promoting consistency and functional integrity of the site. Advantageously, the deployment service 138 may use information concerning the component relationships 122, such as may be accessed and provided by the render service 136, to establish deployment jobs that include each related component to a component set to be deployed. This avoids a number of errors, including, for example, an error that occurs if a first component that references a second component is deployed, but the second component is not deployed. In such a case, any rendered web page may be outdated, having an old second component, or may be incomplete if the second component has not ever been deployed. In addition, the deployment service 138, according to an embodiment, also handles removal or un-deployment of rendered web content from a site. In such a case, the deployment service 138 may ensure that no content is removed if its removal would abandon dependent content. In one embodiment, the deployment service 138 prevents attempts to remove any content upon which other content depends. Alternatively, the deployment service may remove the dependent content along with the other removed content, or may prompt a user or automated process requesting the removal to choose whether to cancel the removal or whether to remove the dependent content along with the other removed content.

A skilled artisan will appreciate that the foregoing discloses a number of functions that may be performed by the deployment service 138, in one embodiment. A skilled artisan will appreciate, however, in light of this disclosure, that these features are not essential features of the deployment service 138. For example, the deployment service 138 need not perform deployment using a number of deployment jobs containing related components. Instead, the deployment service 138 may deploy each component without relation to the deployment of another component. Additionally, the deployment service 138 may deploy content that has not been rendered, or partially rendered content, which may then be rendered at the deployment target 124. Furthermore, although disclosed with reference to an all or nothing deployment, an artisan will recognize from the disclosure herein alternatives to all or nothing deployment, such as, for example, deploying only approved content or deploying content that has passed through a screener, such as, for example, a spell-checker, such that some but not all content within a deployment job may be deployed. These and other alternative implementations of the deployment service 138, such as for example, incremental deployment, in which content that has been updated in a time period, such as the last five minutes is deployed, variation in transport methods used, such as FTP, and the like, will be appreciated by a skilled artisan in light of this disclosure. As such, each disclosed feature of the deployment service 138 describes an exemplary embodiment, and does not limit the deployment service 138 from including alternative or additional features.

In one embodiment, the authentication service 140 provides authentication and security to protect content managed by the web content engine 104. In one embodiment, the authentication service 140 provides login capabilities, maintains developer credentials, and defines access rights for particular content or groups of content. Access rights may define, for example, developers that can or cannot create particular content, modify particular content, delete particular content, or the like. The foregoing authentication and security features operate both on content and content's object model.

According to an embodiment, the workflow process service 134 allows the web content engine 104 to communicate with the workflow process engine 112. Because of this interaction, the web content engine 104 has access to the functionality of the workflow process engine 112. According to an embodiment, the workflow process engine 112 advantageously enforces workflow process definitions stored within the workflow process content 116. That is, in one embodiment, the workflow process engine 112 is configured to interpret the workflow process definitions, determine which operations are to be performed, in which order, and by whom. Additionally, the workflow process engine 112 is configured to route operations to designated participants, receive responses from the participants, and react to the responses according to the defined workflow process. For example, with regard to an exemplary approval workflow process, the workflow process engine 112 may route modified content to a web development supervisor, indicate that the content has been modified, and allow the web development supervisor to approve, edit, or reject the modification. In one embodiment, if the web development supervisor approves, the workflow process engine 112 routes the content to another participant for processing, and so on until the operations defined by the workflow definition have been completed. In light of the interaction between the workflow process service 134, and the workflow process engine 112, the web content engine 104 may take advantage of the foregoing powerful features of the workflow process engine 112. Alternatively or additionally, the web content engine 104 may itself be configured to perform some or all of the functions of the workflow process engine 112, or the web content engine 104 and the workflow process engine 112 may cooperate to enforce workflow definitions stored within the workflow process content 116.

Advantageously, the workflow process service 134 supports, and may cause the workflow process engine 112 to execute, in one embodiment, general workflow process variations that are each configured to enhance aspects of web site integrity. In one embodiment, the workflow process service 134 supports a type of workflow process known herein as a content approval workflow process. In one embodiment, a content approval workflow process comprises a number of ordered operations to be performed by one or more participants to determine if associated web content is approved to be deployed to the deployment target 124. In one embodiment, the participants may be either human or automated processes. In one embodiment, a content approval workflow process causes the workflow process engine 112 to route associated web content to one or more participants and, for each participant, to allow some or all participants to accept, edit, or reject the web content. During an operation of allowing a participant to accept, edit, or reject the web content, the workflow process engine 112 may display the associated web content for viewing by the participant. As will be appreciated by a skilled artisan, in one embodiment, the web content may be rendered prior to displaying the web content to the participant for the foregoing purpose. As such, in one embodiment, the rendered web content 114 may include web content that is going through a content approval workflow process but that has not yet been approved.

In one embodiment, other operations, beyond the foregoing operations for prompting participants to accept, edit, or reject associated content may be supported by the workflow process service 134. For example, in one embodiment, the workflow process service 134 supports an automatic deployment step, in which the deployment service 138 is instructed to commence deployment of the rendered web content 114. Other operations include, for example, version comparison, sending content to a categorization server, sending content to a localization server, format translation, sending content to a user to incorporate into a report, and the like. A skilled artisan will appreciate, in light of this disclosure, that still other operations may be supported, including generally those operations commonly supported by business content management systems and known to a skilled artisan in light of this disclosure.

Advantageously, the workflow process service 134 may launch a content approval workflow process on any web content that has been updated. In one embodiment, the workflow process service 134 has access to associations between individual components and particular content approval workflow processes, between groups of components and particular content approval workflow processes, or both. In one embodiment, components are organized in folders, and each folder constitutes a group of components which may be associated with particular content approval workflow processes. In one embodiment, a content approval workflow process may be associated with page components, template components, asset components, or the like. Based on these associations, the workflow process service 134 may determine, based on the particular component or group of components that has been updated, which content approval workflow process to launch. In one embodiment, an individual component or group of components may be associated with more than one content approval workflow process. In such a case, in one embodiment, the workflow process service 134 may determine which workflow process to launch based on a priority level assigned to each workflow process. Alternatively or additionally, the workflow process service 134 may choose to launch the workflow process that was first created or first associated with the component or group of components. A skilled artisan will appreciate, in light of this disclosure, that combinations of some or all of the foregoing can be employed to determine which workflow process to launch.

Advantageously, a content approval workflow process may be launched when content changes and also when links or relationships among content changes. The web content engine 104 tracks a number of links and relationships among components, including, for example, two link types known herein as soft links and hard links. Soft links comprise links generated automatically by the web content engine 104. Such links may be generated, for example, by embedding the output of a function in a component, such as, for example, by embedding a Java method or macro functions. One example in which the output of a function may be so embedded is, in one embodiment, a Folder.toListing function that receives a reference to a folder and generates as output a listing of components within the folder. Such a function may be useful, for example, to generate a navigation bar. A skilled artisan will appreciate, in light of this disclosure, that this feature of embedding function outputs within a component allows a developer 126 to more efficiently develop web content by automating portions of development. A skilled artisan will also appreciate, in light of the foregoing, that any number of functions, including, for example, any number of Java methods, may be embedded after this fashion. Hard links comprise links generated by developer design, such as, for example, by hard-coding a reference to a component into a template component. In an embodiment, both soft links and hard links are tracked by the web content engine 104, and a modification to a link, such as, for example, when a linked component changes locations, may trigger a content approval workflow process on a component linking to the moved linked component. In one embodiment, static links, or hard-coded URL links, are possible, but may not be tracked by the web content engine 104. Alternatively, static links, some or all static links may be tracked by the web content engine 104. In one embodiment, static links that are internal relative links may be tracked by the web content engine 104.

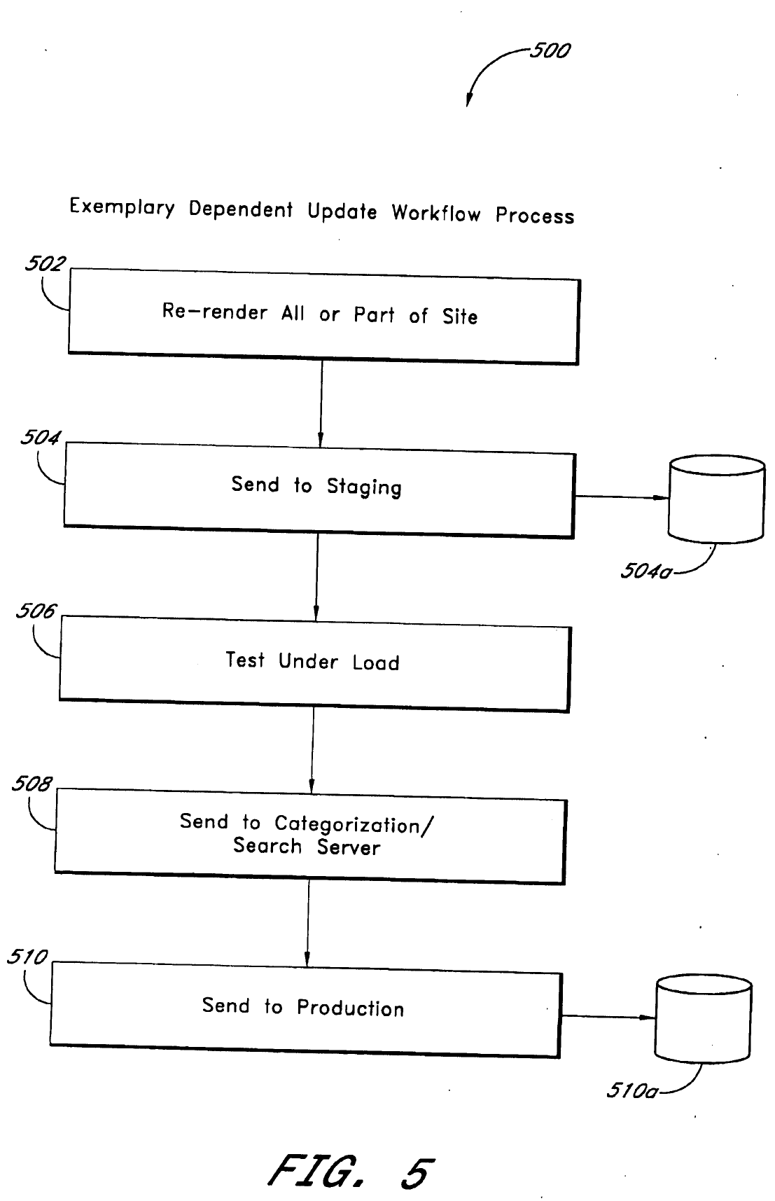

Another type of workflow process is known herein as a dependent update workflow process. In one embodiment, a dependent update workflow process may be launched upon a page component when one of the page component's children components is created, updated, or deleted. In addition to page components, a dependent update workflow process may be launched on other objects, such as, for example text files. As with content approval workflow processes, in one embodiment, the workflow process service 134 has access to associations between individual components and particular dependent update workflow processes, between groups of components and particular dependent update workflow processes, or both. In one embodiment, components are organized in folders, and each folder constitutes a group of components which may be associated with particular dependent update workflow processes. As with content approval workflow processes, dependent update workflow processes advantageously may include any number of developer-selected operations or steps to be performed on each dependent page component. An advantageous usage of these workflow processes is to include a deployment step that, for example, re-renders a page and deploys it to the development target 124. Another version is explained in more detail later with reference to FIG. 5. A skilled artisan will appreciate that many other uses for dependent update workflow processes are possible, such as for example, format conversion, distribution, and categorization. The workflow process service 134 may choose a particular dependent update workflow process to launch based on which dependent page is involved, which component has been updated, a combination of the two factors, some combination of one or both factors with other criteria, or criteria independent of both factors. Additionally, multiple dependent update workflow processes can be associated with and executed on components.

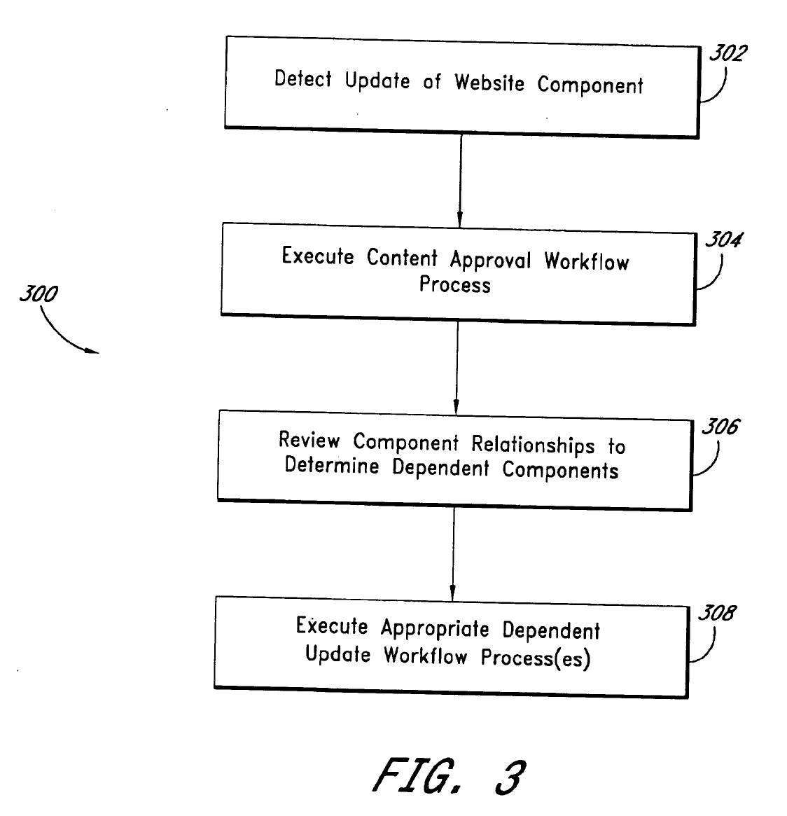

FIG. 3 is a flowchart illustrating an exemplary web content update process 300 that may be employed by the web content management system of FIG. 1A. As illustrated, in one embodiment of the process 300, a content approval workflow process and a dependent update workflow process are employed. Advantageously, the workflow process results in the preservation of referential integrity. According to an embodiment, in a block 302 an update of a web site component is detected. In one embodiment, the detection occurs with the aid of the render service 136, which tracks information about the component relationships 122. In a block 304, a content approval workflow process is executed on the updated component. In one embodiment, an appropriate content approval workflow process is chosen, based on either the identity of the updated component, its belonging to a particular group of components, some combination of the above, or some other criteria. A launched content approval workflow process can, in turn, launch one or more processes for performing operations defined by the content approval workflow process. In a block 306, component relationships are reviewed to determine which, if any, components depend on the updated component. For example, with respect to FIG. 2A, if the logo asset component 212 is updated, the component relationships may be reviewed to determine that the products page component 204 and the support page component 232 depend on the updated component.

In a block 308, an appropriate dependent update workflow process is executed. In an embodiment, an optional appropriate dependent update workflow process is executed on a particular page component that is dependent on the updated component. Advantageously, completion of the foregoing workflow processes may be followed by deployment of any web content that successfully passes through the workflow processes. Advantageously, the use of content approval workflow processes such as the foregoing increases web site integrity by ensuring that content passes through an approval process prior to being deployed. Such approval processes increase web site integrity by, for example, allowing one or more participants to detect erroneous content and reject the content or edit the content prior to deployment. Additionally, the use of dependent update workflow processes ensures that content follows a defined update procedure as it is propagated throughout a web site, also increasing web site integrity. A skilled artisan will appreciate, in light of this disclosure, that additional operations may be performed along with those listed, without fundamentally altering the foregoing method.

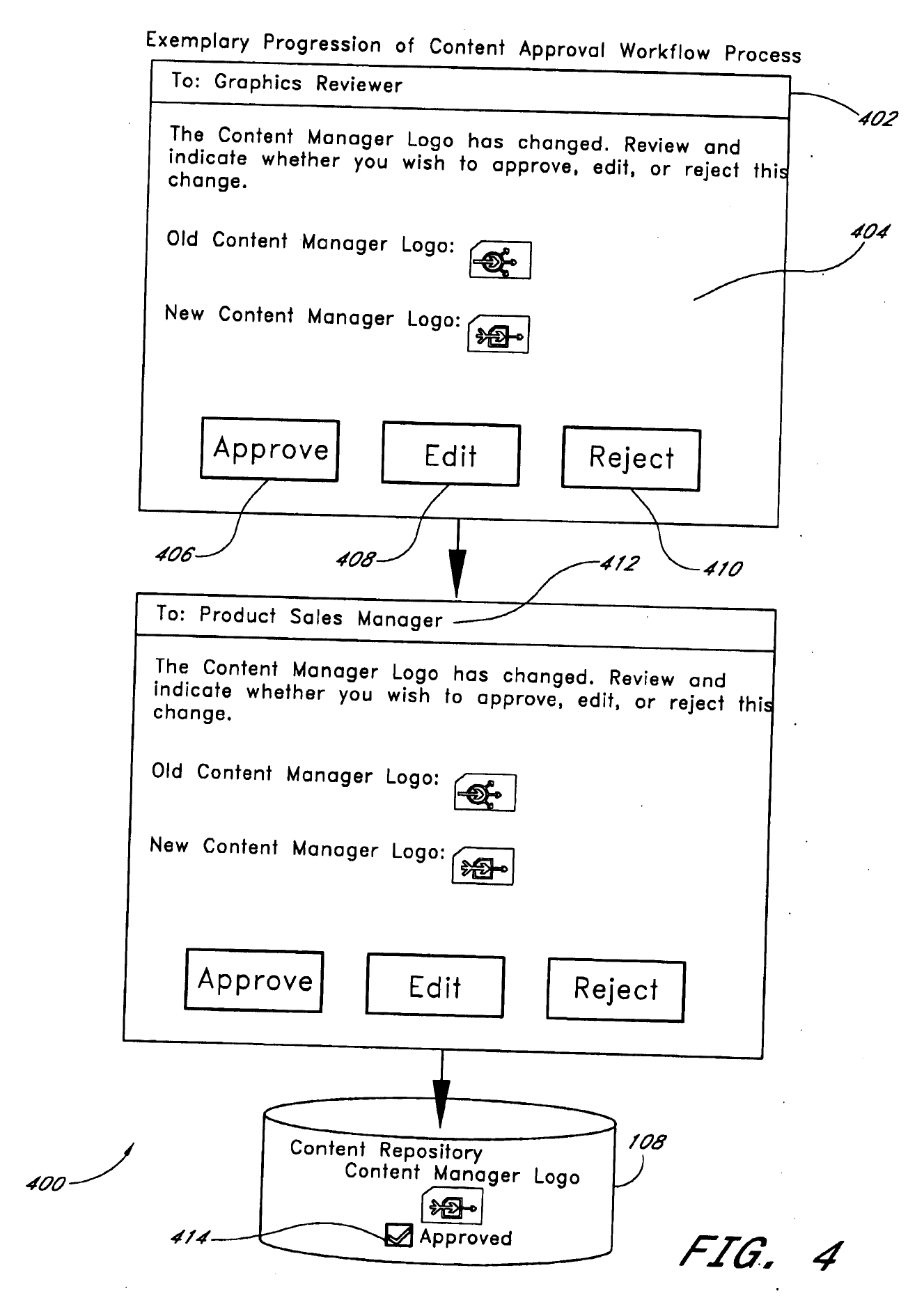

FIG. 4 is a graphical representation of an exemplary progression of a content approval workflow process 400 that may be employed by the web content management system of FIG. 1A. In the illustrated example, a content approval workflow process occurs upon an update of a logo. A simplified screen shot 402 illustrates an operation in which a graphics reviewer is presented, in a display area 404, with the updated logo and the older logo and allowed to approve 406, edit 408, or reject 410 the change. A simplified screen shot 412 shows a second operation in which a product sales manager is presented with the same information and with the same options. A depiction of the content repository 108 indicates that the updated logo successfully passed through the approval process and is stored within the content repository 108 within an indication 414 that the logo has been approved.

FIG. 5 is a flowchart illustrating an exemplary dependent update workflow process 500 that may be employed by the web content management system of FIG. 1A. In a block 502, some or all of a web site is re-rendered. Re-rendered portions of a web site include, in one embodiment, pages that depend on an updated component that has triggered a dependent update workflow process. In a block 504, the site is sent to a staging server 504a. The staging server 504a is a temporary deployment target at which the site can be tested prior to public deployment. In a block 506, the site may be tested under a load. This testing may be performed using, for example, testing suite applications for subjecting the site to repeated use. Alternatively or in combination, the site may be tested by a number of human testers, such as, for example, beta testers. In a block 508, the site may be sent to a categorization and search server. The categorization and search server may recategorize the content of the site, build a new index for the site, and facilitate, based on the foregoing, searches of the site. In a block 510, the site may be deployed to a production server 510a. In light of the foregoing, a skilled artisan will appreciate that dependent update workflow processes may be used to ensure that a proper procedure is followed during an update of a web page that depends on previously updated components. By using dependent update workflow processes to ensure adherence to such procedure, a developer 126 may avoid web site development errors, such as, for example, a failure to re-render a web page that includes an updated component. In addition to the foregoing operations, a skilled artisan will appreciate, in light of this disclosure, other operations that may be included in a dependent update workflow process, such as, for example, previously listed operations.

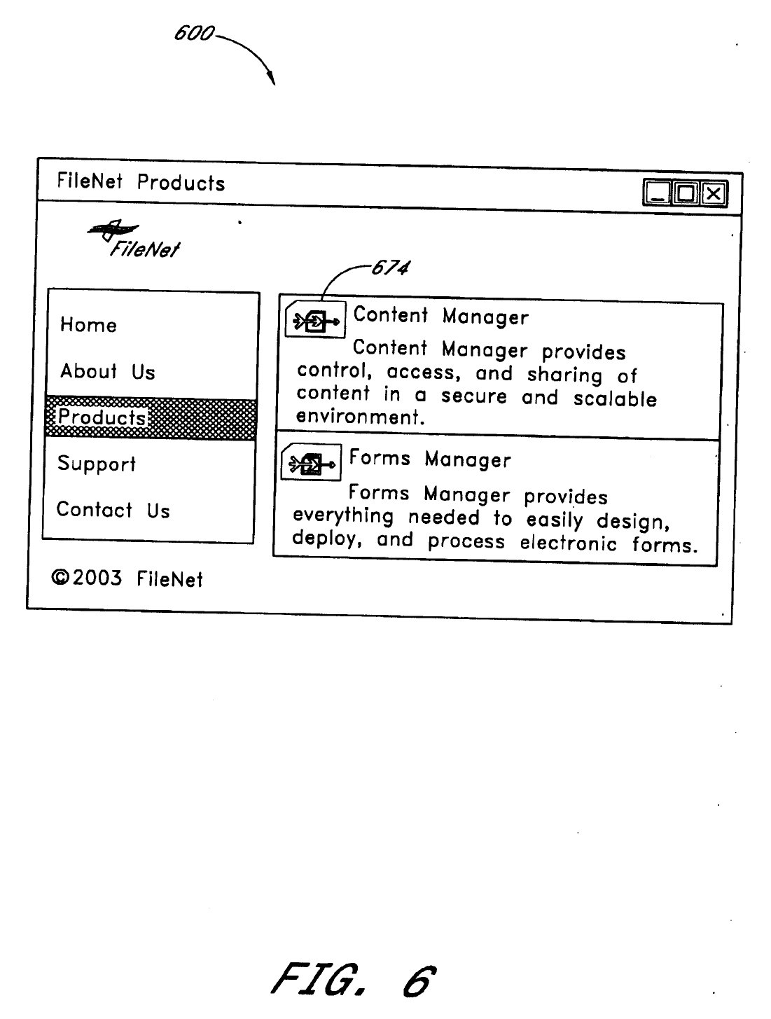

FIG. 6 is a simplified screen shot of an exemplary rendered web page 600 modified from the exemplary page of FIG. 2C, using the web content management system of FIG. 1A. For purposes of this example, the exemplary rendered web page 600 has been modified in accordance with the exemplary progression of a content workflow process 400 of FIG. 4, in which an old logo for a Content Manager product was replaced with a new logo. As previously disclosed, in one embodiment the update modifies the content manager logo asset 224, such that, for example, it points to new content. For example, with regard to FIGS. 2A-2B, after the update, the content manager logo asset 224, which previously pointed to a logo image file, “Content.GIF,” 224a may now point to a different logo image file, such as, for example, “NewContent.GIF.” Advantageously, the modification of one component, the content manager logo asset 224, causes the web site to be updated at every location where the updated component occurs, such as, for example, both in the products page component 204 and the support page component 232. A skilled artisan will appreciate, in light of this disclosure, that the update of each page component may be implemented, in one embodiment, by a dependent update workflow process that may execute on each dependently-update page component. Such dependent update workflow processes may, for example, re-render the web page for public display. Comparing FIG. 6 with FIG. 2C, it is apparent that new logo 674 has indeed been rendered. Additionally, it is apparent that the rest of the rendered page 600 remains the same as the rendered page 250.

While the foregoing disclosure has disclosed a number of embodiments of a web content management system 102 as described, it does not define the invention. A skilled artisan will appreciate, in light of this disclosure, how to practice the embodiments of the systems and methods disclosed herein, as well as additional embodiments that will be appreciated by a skilled artisan to be consistent with these embodiments and the principles disclosed herein. The claims alone, and no other part of this disclosure, define the invention.

What is claimed is:

1. A web content management system for updating web content, the web content management system comprising a web content engine configured to access a plurality of components used to define content associated with at least one web site, configured to determine whether one or more of the plurality of components has been modified, and configured to submit a workflow definition to a workflow process engine, wherein the workflow definition defines one or more ordered operations to be performed by at least one participant in the approval of the one or more modified components.

2. The web content management system of claim 1, wherein the plurality of components form an ordered structure of the plurality of components and relationships between the plurality of components.

3. The web content management system of claim 2, further comprising a repository for storing the plurality of components and the relationships.

4. The web content management system of claim 1, wherein the web content engine is further configured to submit a dependent update workflow definition to the workflow process engine.

5. The web content management system of claim 4, wherein the dependent update workflow definition defines one or more ordered operations to be performed by at least one participant in the rerendering of web pages incorporating the one or more modified components.

6. The web content management system of claim 1, wherein the web content engine further comprises a rendering service configured to render the web site from the plurality of components.

7. The web content management system of claim 1, wherein the web content engine further comprises a deployment service capable of deploying the web site to a target system.

8. The web content management system of claim 7, wherein the deployment service deploys related components in a single transaction.

9. The web content management system of claim 8, wherein if at least one component being deployed during the single transaction fails to properly deploy, the single transaction is deemed to have failed.

10. The web content management system of claim 9, wherein the deployment service is capable of rolling back any failed single transaction.

11. The web content management system of claim 1, wherein the plurality of components comprise an atomic component, a composite component, and a page component.

12. A web content management system comprising:
a web content engine configured to access a plurality of components defining content associated with at least one web site; and
a workflow process engine configured to access a plurality of workflow processes defining ordered operations to be performed on one or more of the plurality of components by at least one participant to render some or all of the at least one web site.

13. The web content management system of claim 12, wherein at least one of the one or more workflow processes comprises a deployment operation.

14. The web content management system of claim 13, wherein the deployment operation deploys related components in a single transaction.

15. The web content management system of claim 14, wherein if at least one component being deployed fails to deploy correctly, the transaction is rolled back.

16. The web content management system of claim 12, wherein the plurality of components comprise a plurality of atomic components defining at least a portion of content of a web site and a plurality of structured components defining at least a portion of structure of a web site that includes a reference to the atomic component and a structured component, wherein each structured component is deemed to be dependent on any component included, by reference, within the structured component.

17. The web content management system of claim 16, wherein the plurality of structured components comprise at least a plurality of page components, wherein each page component defines structure and content of a web page.

18. A method of checking integrity of an update to a web site component that defines a portion of a website, comprising:
detecting an update of a web site component, and
executing a content approval workflow process to assess whether the updated web site component is approved.

19. The method of claim 18, further comprising:
reviewing a plurality of component relationships to determine components that depend on the updated component; and
executing an appropriate dependent update workflow process.

20. The method of claim 18, wherein the executing a content approval workflow process comprises executing a content approval workflow process that is capable of including at least one defined operation that asks a participant to accept, edit, or reject, the update to the web site component.

21. The method of claim 18, wherein detecting an update of a web site component includes detecting an addition of a new component to an existing folder including web site components.

22. The method of claim 18, wherein detecting an update of a web site component includes detecting a deletion of a component.

23. The method of claim 18, wherein executing a content approval workflow process includes identifying at least one association between the updated component and at least one of a plurality of defined workflow processes.

24. The method of claim 23, wherein identifying at least one association includes identifying at least one association between the updated component and at least one of a plurality of defined workflow processes based on membership, by the updated component, in a group of components associated with a defined workflow process.

25. The method of claim 23, wherein identifying at least one association includes identifying more than one association and determining based on a criteria, which of the more than one associated content approval workflows to execute.

26. A method of checking integrity of an update to a web site component that defines a portion of a website, comprising:
detecting an update of a web site component, the web site component being one of a plurality of web site components defining structure and content of a web site, wherein the plurality of web site components are stored in a multi-level hierarchical structure;
reviewing a plurality of relationships to determine components that depend on the updated component; and
executing at least one operation on at least one of the determined dependent components, wherein the at least one executed operation relates to updating the at least one determined dependent component.
